(19) United States
(12) Patent Application Publication
(10) Pub. No.: US 2025/0081214 A1
(43) Pub. Date: Mar. 6, 2025

(54) WAKE-UP INDICATION IN SCI

(71) Applicant: Samsung Electronics Co., Ltd., Suwon-si (KR)

(72) Inventors: Hongbo Si, Allen, TX (US); Kyeongin Jeong, Allen, TX (US); Emad Nader Farag, Flanders, NJ (US); Anil Agiwal, Allen, TX (US)

(21) Appl. No.: 18/805,257

(22) Filed: Aug. 14, 2024

Related U.S. Application Data
(60) Provisional application No. 63/535,213, filed on Aug. 29, 2023.
(60) Provisional application No. 63/541,527, filed on Sep. 29, 2023.

(51) Int. Cl. H04W 72/25; H04W 72/044; H04W 76/28

(52) U.S. Cl. CPC H04W 72/25; H04W 72/044; H04W 76/28

(57) ABSTRACT

Methods and apparatuses for wake-up indication in sidelink control information (SCI) in a wireless communication system. A method of a user equipment (UE) in a wireless communication system includes receiving a set of configurations or pre-configurations, determining, based on the set of configurations or pre-configurations, at least one sidelink (SL) discontinuous reception (DRX) configuration, determining a DRX cycle based on the at least one SL DRX configuration and determining an active time duration in the DRX cycle. The method further includes determining reception occasions of a first SCI format that are before a start of the active time duration, determining whether the first SCI format is received based on the reception occasions and when the first SCI format is received in the reception occasions, determining, based on an indication in the first SCI format, whether to receive a second SCI format in the active time duration.

### CROSS-REFERENCE TO RELATED APPLICATIONS AND CLAIM OF PRIORITY

The present application claims priority to U.S. Provisional Patent Application No. 63/535,213, filed on Aug. 29, 2023 and U.S. Provisional Patent Application No. 63/541,527, filed on Sep. 29, 2024. The contents of the above-identified patent documents are incorporated herein by reference.

### TECHNICAL FIELD

The present disclosure relates generally to wireless communication systems and, more specifically, the present disclosure relates to a wake-up indication in sidelink control information (SCI) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a wake-up indication in SCI in a wireless communication system.

In one embodiment, a user equipment (UE) in a wireless communication system is provided. The UE includes a transceiver configured to receive a set of configurations or pre-configurations and a processor operably coupled to the transceiver. The processor is configured to determine, based on the set of configurations or pre-configurations, at least one sidelink (SL) discontinuous reception (DRX) configuration; determine a DRX cycle based on the at least one SL DRX configuration; determine an active time duration in the DRX cycle; determine reception occasions of a first SCI format that are before a start of the active time duration; determine whether the first SCI format is received based on the reception occasions; and when the first SCI format is received in the reception occasions, determine, based on an indication in the first SCI format, whether to receive a second SCI format in the active time duration.

In another embodiment, a method of a UE in a wireless communication system is provided. The method includes receiving a set of configurations or pre-configurations; determining, based on the set of configurations or pre-configurations, at least one SL DRX configuration; determining a DRX cycle based on the at least one SL DRX configuration; and determining an active time duration in the DRX cycle. The method further includes determining reception occasions of a first SCI format that are before a start of the active time duration; determining whether the first SCI format is received based on the reception occasions; and when the first SCI format is received in the reception occasions, determining, based on an indication in the first SCI format, whether to receive a second SCI format in the active time duration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of resource pool in NR V2X according to embodiments of the present disclosure;

FIG. 7 illustrates an example of slot structure for SL transmission and reception according to embodiments of the present disclosure;

FIG. 8 illustrates an example of SL DRX according to embodiments of the present disclosure;

FIG. 9 illustrates an example of wake-up indication for SL DRX according to embodiments of the present disclosure;

FIG. 10 illustrates a flowchart of UE procedure for a wake-up indication for SL DRX according to embodiments of the present disclosure;

FIG. 11 illustrates an example of wake-up indication per DRX configuration according to embodiments of the present disclosure;

FIG. 12 illustrates an example of wake-up indication per DRX cycle configuration according to embodiments of the present disclosure;

FIG. 13 illustrates an example of common wake-up indication per shortest DRX cycle according to embodiments of the present disclosure;

FIG. 14 illustrates an example of sensing windows and resource selection window for SL WUS according to embodiments of the present disclosure; and

FIG. 15 illustrates a flowchart of UE procedure for resource allocation of SL WUS in mode 2 according to embodiments of the present disclosure.

### DETAILED DESCRIPTION

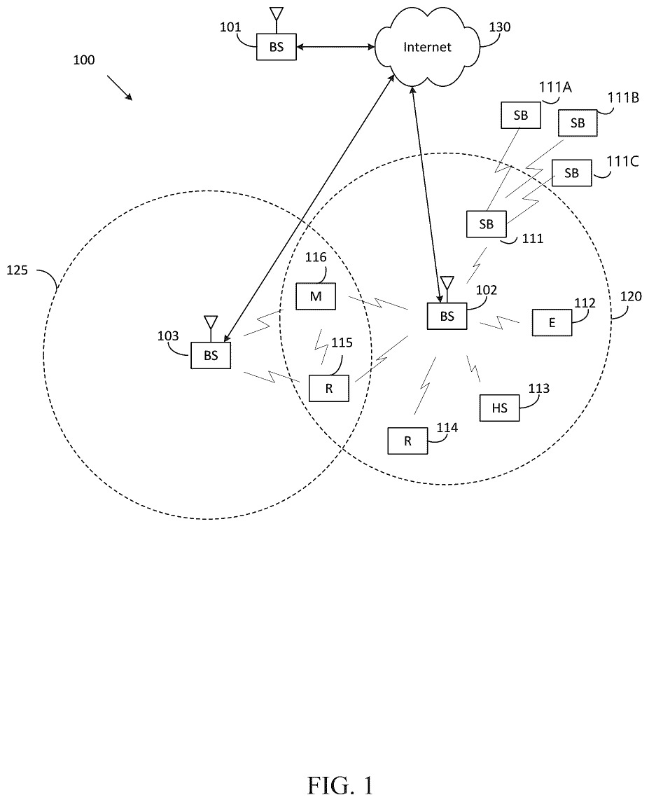

FIGS. 1-15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and channel coding”; 3GPP TS 38.213 v16.1.0, “NR; Physical layer procedures for control”; 3GPP TS 38.214 v16.1.0, “NR; Physical layer procedures for data”; and 3GPP TS 38.331 v16.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a wake-up indication in SCI in a wireless communication system. In certain embodiments, and one or more of the gNBs 101-103 includes circuitry, programing, or a combination thereof, for supporting a wake-up indication in SCI in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

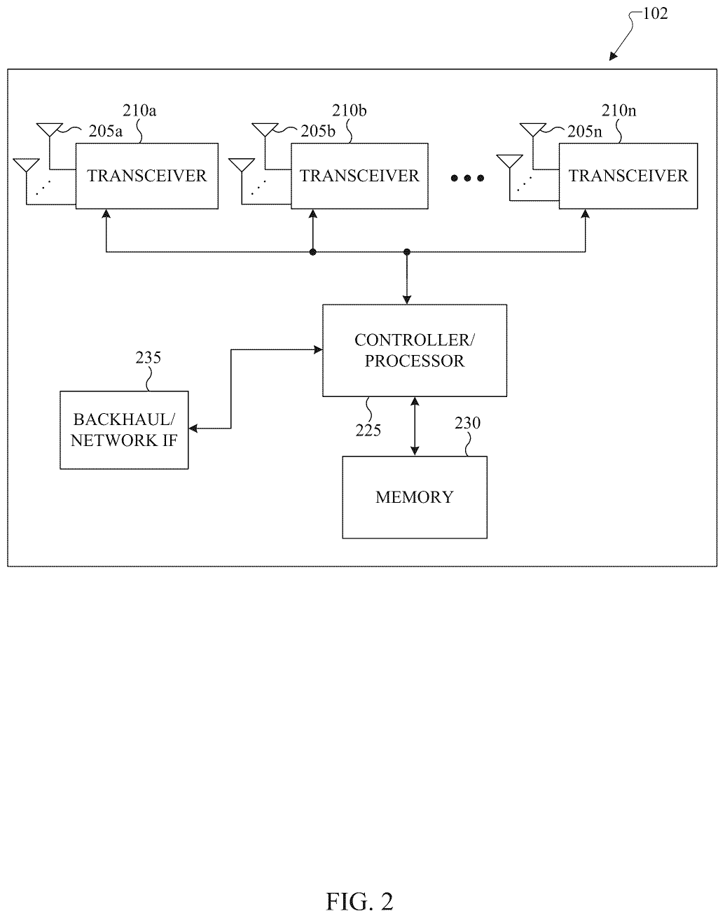

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a wake-up indication in SCI in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

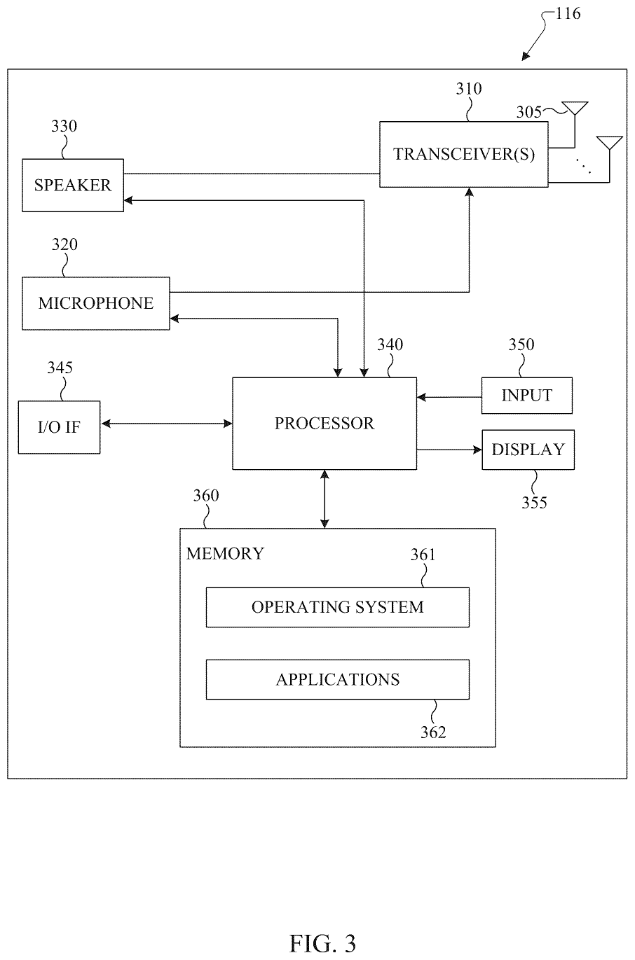

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a wake-up indication in SCI in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

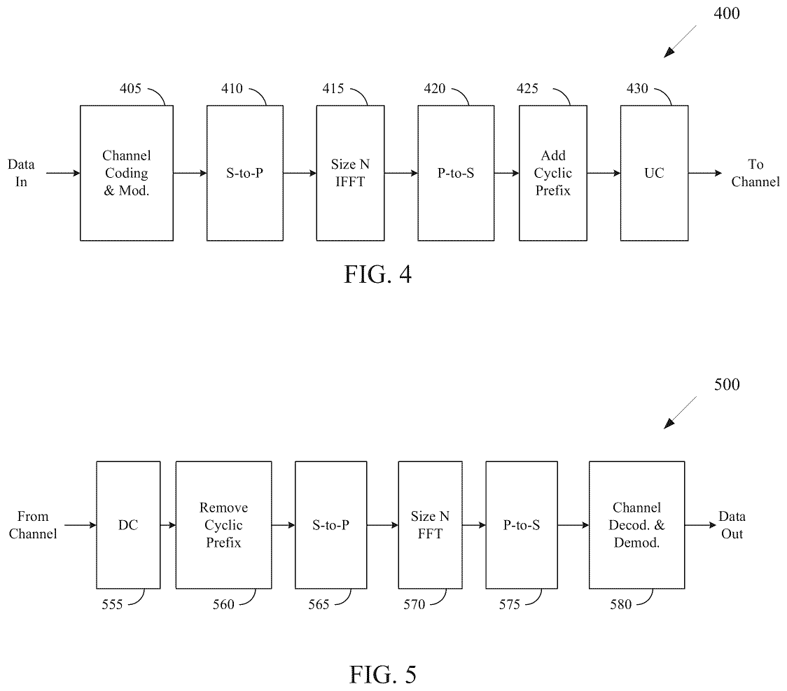

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the receive path 500 is configured to support a wake-up indication in SCI in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In Rel-16 NR V2X, transmission and reception of SL signals and channels are based on resource pool(s) confined in the configured SL bandwidth part (BWP). In a frequency domain, a resource pool includes a (pre-)configured number (e.g., sl-NumSubchannel) of contiguous sub-channels, wherein each sub-channel includes a set of contiguous resource blocks (RBs) in a slot with size (pre-)configured by higher layer parameter (e.g., sl-SubchannelSize).

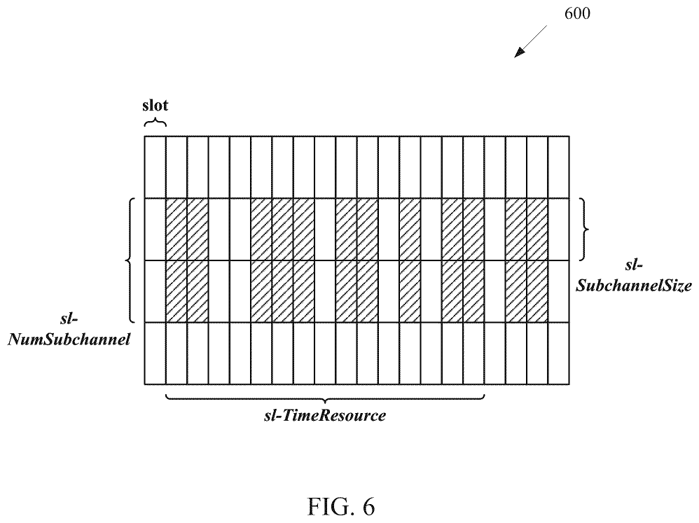

In a time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). An illustration of a resource pool is shown in FIG. 6.

FIG. 6 illustrates an example of resource pool in NR V2X according 600 to embodiments of the present disclosure. An embodiment of the resource pool in NR V2X according 600 shown in FIG. 6 is for illustration only.

A transmission and reception of physical sidelink shared channel (PSSCH), a physical sidelink control channel (PSCCH), and a physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for sidelink, e.g., startSLsymbol+1, and the first symbol configured for sidelink is duplicated from the second configured for sidelink, for AGC purpose. The UE may not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

For transmitting a PSSCH, the UE can be provided a number of symbols (either 2 symbols or 3 symbols) in a resource pool (e.g., sl-TimeResourcePSSCH) starting from the second symbol configured for sidelink, e.g., startSLsymbol+1; and further provided a number of RBs in the resource pool (e.g., sl-FreqResourcePSSCH) starting from the lowest RB of the lowest sub-channel of the associated PSSCH.

The UE can be further provided a number of slots (e.g., sl-PSFCH-Period) in the resource pool for a period of PSFCH transmission occasion resources, and a slot in the resource pool is determined as containing a PSFCH transmission occasion if the relative slot index within the resource pool is an integer multiple of the period of PSFCH transmission occasion. PSFCH is transmitted in two contiguous symbols in a slot, wherein the second symbol is with index startSLsymbols+lengthSLsymbols−2, and the two symbols are repeated. In a frequency domain, PSFCH is transmitted in a single RB, wherein orthogonal cover code (OCC) can be possibly applied within the RB for multiplexing, and the location of the RB is determined based on an indication of a bitmap (e.g., sl-PSFCH-RB-Set), and the selection of PSFCH resource is according to the source ID and destination ID.

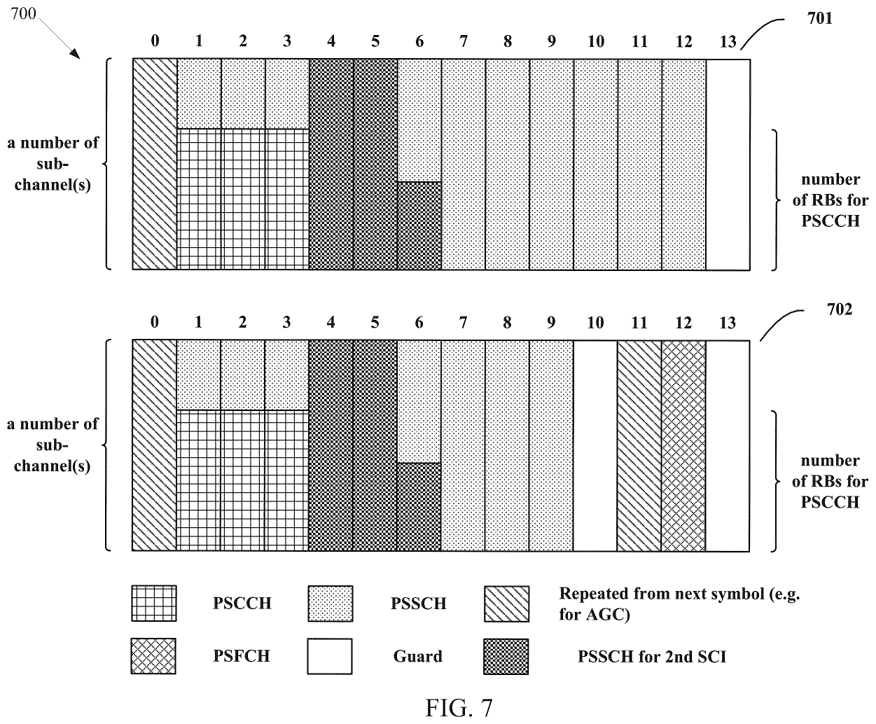

The first symbol including PSSCH and PSCCH is duplicated for AGC purpose. An illustration of the slot structure including PSSCH and PSCCH is shown in 701 as illustrated in FIG. 7, and the slot structure including PSSCH, PSCCH and PSFCH is shown in 702 as illustrated in FIG. 7.

FIG. 7 illustrates an example of slot structure for SL transmission and reception 700 according to embodiments of the present disclosure. An embodiment of the slot structure for SL transmission and reception 700 shown in FIG. 7 is for illustration only.

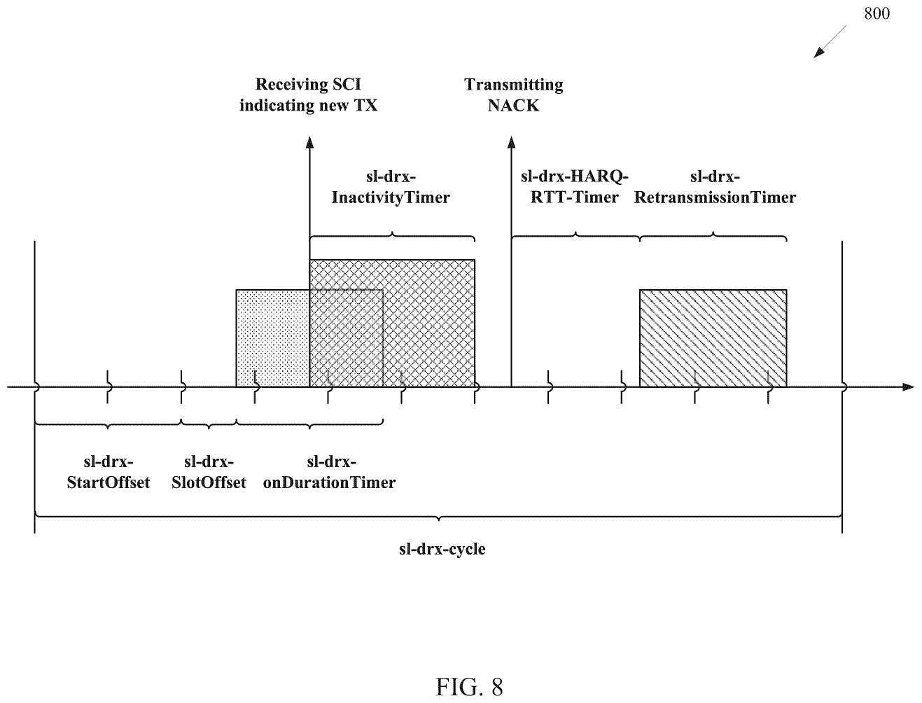

To save UE's power on a sidelink, a sidelink discontinuous reception scheme (SL DRX) is supported. The SL DRX functionality controls the UE's sidelink control information (SCI), e.g., including the first stage SCI and the second stage SCI, monitoring activity for unicast, for groupcast and broadcast. A set of SL DRX configurations include a DRX cycle (e.g., sl-drx-cycle), a subframe level time offset (e.g., sl-drx-StartOffset), a slot level time offset (e.g., sl-drx-SlotOffset), an on duration timer (e.g., sl-drx-onDurationTimer), an inactivity timer (e.g., sl-drx-HARQ-RTT-Timer), a HARQ RTT timer, and a retransmission timer (e.g., sl-drx-RetransmissionTimer), wherein the subframe level time offset and the slot level time offset are determined based on L2 destination ID for groupcast and broadcast, and the inactivity timer, the HARQ RTT timer, and the retransmission timer are not applicable for broadcast. A set of SL DRX configurations is applicable per a pair of L2 destination ID and L2 source ID for unicast and is applicable per L2 destination ID and QoS profile for groupcast and broadcast. An illustration of the configurations for SL DRX and the procedure for the timers is shown in FIG. 8.

FIG. 8 illustrates an example of SL DRX 800 according to embodiments of the present disclosure. An embodiment of the SL DRX 800 shown in FIG. 8 is for illustration only.

To further save power on a sidelink, a wake-up mechanism associated with the SL DRX can be supported, wherein a UE can determine whether to wake up during a SL DRX cycle to receive the SCI. This disclosure describes the details on the wake-up indication by a SCI.

The present disclosure describes the details on the resource allocation for the signal/channel that carries the wake-up indication (e.g., WUS), e.g., a PSCCH and/or a PSSCH carrying the SCI format that includes the wake-up indication.

The present disclosure focuses on the wake-up indication in sidelink control information to save power of a UE. More precisely, the following aspects are included in the present disclosure: (1) a wake-up indication for a single SL DRX procedure; and (2) a wake-up indication for multiple SL DRX configurations: (i) a separate wake-up signal per SL DRX configuration, (ii) a common wake-up signal per shortest SL DRX cycle, and (iii) a common wake-up signal per longest SL DRX cycle.

The present disclosure also provides for resource allocation for transmitting a sidelink signal/channel to carry a wake up indication and to save power of a UE. More precisely, the following aspects are provided in the present disclosure: (1) resource allocation for sidelink wake up signal in mode 1; and (2) resource allocation for sidelink wake up signal in mode 2: (i) a UE procedure for determining a resource selection window for a sidelink wake up signal; (ii) a UE procedure for determining at least one resource sensing window for a sidelink wake up signal, and (iii) a UE procedure for excluding candidate resource from the resource selection window based on the sensing results from the at least one resource sensing window.

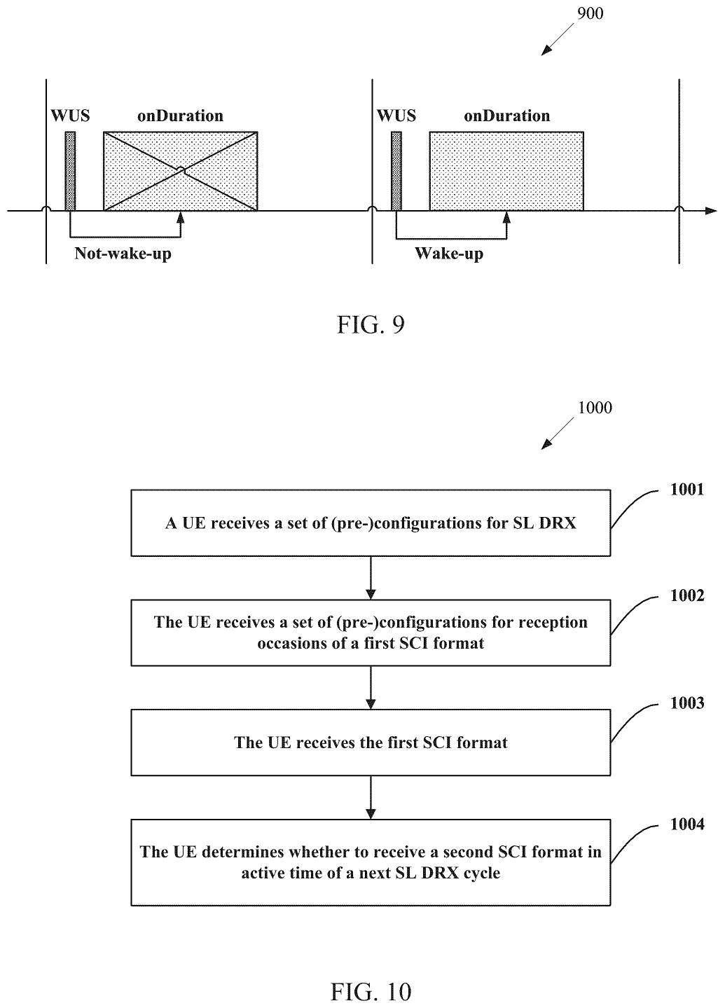

In one embodiment, a first SCI format can include a field indicating whether to wake up and/or receive a second SCI format during an active time duration in a DRX cycle (e.g., an active time duration can be defined as when at least one of on duration timer, inactivity timer, or retransmission timer is running). For this embodiment, the wake-up indication is associated with a single SL DRX cycle in the SL DRX operation, wherein the SL DRX operation can be determined based on a single SL DRX operation (e.g., for unicast, or single SL DRX configuration for groupcast or broadcast), or based on multiple SL DRX operations (e.g., for groupcast or broadcast). The first SCI format can also be denoted as wake-up-signal (WUS) for this embodiment, and an illustration of this embodiment is shown in FIG. 9.

FIG. 9 illustrates an example of wake-up indication for SL DRX 900 according to embodiments of the present disclosure. An embodiment of the wake-up indication for SL DRX 900 shown in FIG. 9 is for illustration only.

For one example, the first SCI format is a first stage SCI format, e.g., SCI format 1-A, and a reserved bit can be used for the wake-up indication.

For another example, the first SCI format is a second stage SCI format, e.g., SCI format 2-A.

For yet another example, the first SCI format is a second stage SCI format, e.g., SCI format 2-B.

For yet another example, the first SCI format is a second stage SCI format, e.g., SCI format 2-C.

For one example, the occasion(s) for receiving the first SCI format can be determined based on a set of configurations.

For one instance, the occasion(s) for receiving the first SCI format can be determined as a time domain window before the start of the active time duration (e.g., on duration timer) in the DRX cycle.

For one instance, the starting location of the time domain window can be determined by a time domain offset with respect to the start of the active time duration (e.g., on duration timer) in the DRX cycle, wherein the time domain offset can be provided by a higher layer parameter and/or a pre-configuration.

For another instance, the duration of the time domain window can be provided by a higher layer parameter and/or a pre-configuration.

For yet another instance, the gap between the ending time of the time domain window and the starting time of the active time duration (e.g., on duration timer) in the DRX cycle may need to be larger than (or no less than) a threshold. For one instance, the threshold can be provided by a higher layer parameter and/or a pre-configuration. For another instance, the threshold can be subject to a UE capability.

For another example, the occasion(s) for receiving the first SCI format can be determined as a slot before the start of the active time duration (e.g., on duration timer) in the DRX cycle.

For one instance, the slot can be determined by a time domain offset with respect to the start of the active time duration (e.g., on duration timer) in the DRX cycle, wherein the time domain offset can be provided by a higher layer parameter and/or a pre-configuration.

For another instance, the gap between the slot and the starting time of the active time duration (e.g., on duration timer) in the DRX cycle may need to be larger than (or no less than) a threshold. For one instance, the threshold can be provided by a higher layer parameter and/or a pre-configuration. For another instance, the threshold can be subject to a UE capability.

For yet another example, the occasion(s) for receiving the first SCI format can be determined as part of active time duration for the SL DRX operation.

For one example, the field for a wake-up indication has 1 bit.

For another example, the field for a wake-up indication has 1 bit if a higher layer parameter is provided (e.g., higher layer parameter indicating whether the wake-up indication for SL DRX is enabled), and 0 bit otherwise.

For one example, the bit taking a first value (e.g., 1) indicates that the UE may need to wake up and receive the second DCI format during an active time duration in a next DRX cycle after the reception of the wake-up indication; and the bit taking a second value (e.g., 0) indicates that the UE may not need to wake up and can skip receiving the second DCI format during an active time duration in a next DRX cycle after the reception of the wake-up indication.

For one example, when the first SCI format is associated with a unicast transmission (e.g., the first SCI format indicates a cast type as unicast, or the associated second stage SCI indicates a cast type as unicast, or the associated second stage SCI is a SCI format 2-C), the DRX cycle is the one associated with the pair of L2 destination ID and L2 source ID.

For another example, when the first SCI format is associated with a groupcast or broadcast transmission (e.g., the first SCI format indicates a cast type as groupcast or broadcast, or the associated second stage SCI indicates a cast type as groupcast or broadcast, or the associated second stage SCI is a SCI format 2-B), the DRX cycle is the one associated with the L2 destination ID, and applicable for all QoS profiles.

For one example, a transmitter UE can transmit more than one the first SCI format before a DRX active time duration (e.g., on duration timer). For one instance, a receiver UE can assume the wake-up indication in the more than one the first SCI format is the same. For another instance, a receiver UE may assume the wake-up indication in a later time domain occasion overrides the wake-up indication in an earlier time domain occasion within the more than one the first SCI format.

For one example, if a UE does not receive any first SCI format in the occasion(s) for receiving the first SCI format, the UE may wake up and receive the second DCI format during an active time duration in a next DRX cycle.

For one example, when a UE is configured with configurations to receive the first SCI format, the procedure for receiving the first SCI format can be terminated by a first medium access control control element (MAC CE). For another example, when a UE is indicated to wake up and receive the second SCI format, the procedure for receiving the second SCI format can be terminated by a second MAC CE.

FIG. 10 illustrates a flowchart of UE method 1000 for a wake-up indication for SL DRX according to embodiments of the present disclosure. The UE method 1000 as may be performed by a UE (e.g., 111-116 as illustrated in FIG. 1). An embodiment of the UE method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, in step 1001, a UE receives a set of configurations (or pre-configurations) for SL DRX. Subsequently, in step 1002, the UE receives a set of configurations (or pre-configurations) for reception occasions of a first SCI format. In step 1003, the UE receives the first SCI format. Finally, in step 1004, the UE determines whether to receive a second SCI format in active time of a next SL DRX cycle.

In one embodiment, a first SCI format can include a field indicating whether to wake up and/or receive a second SCI format during an active time duration in a DRX cycle (e.g., the active time duration can be defined as when at least one of on a duration timer, an inactivity timer, or a retransmission timer is running), when one or multiple SL DRX configurations are provided. For this embodiment, the wake-up indication can be associated with one or multiple SL DRX cycles and/or one or multiple SL DRX configurations. For instance, this embodiment can be applicable for groupcast and unicast, wherein one or multiple SL DRX configurations can be provided, e.g., for one or multiple QoS profiles. The first SCI format can also be denoted as WUS for this embodiment.

For one example, the first SCI format is a first stage SCI format, e.g., SCI format 1-A, and a reserved bit can be used for the wake-up indication.

For another example, the first SCI format is a second stage SCI format, e.g., SCI format 2-A.

For yet another example, the first SCI format is a second stage SCI format, e.g., SCI format 2-B.

For yet another example, the first SCI format is a second stage SCI format, e.g., SCI format 2-C.

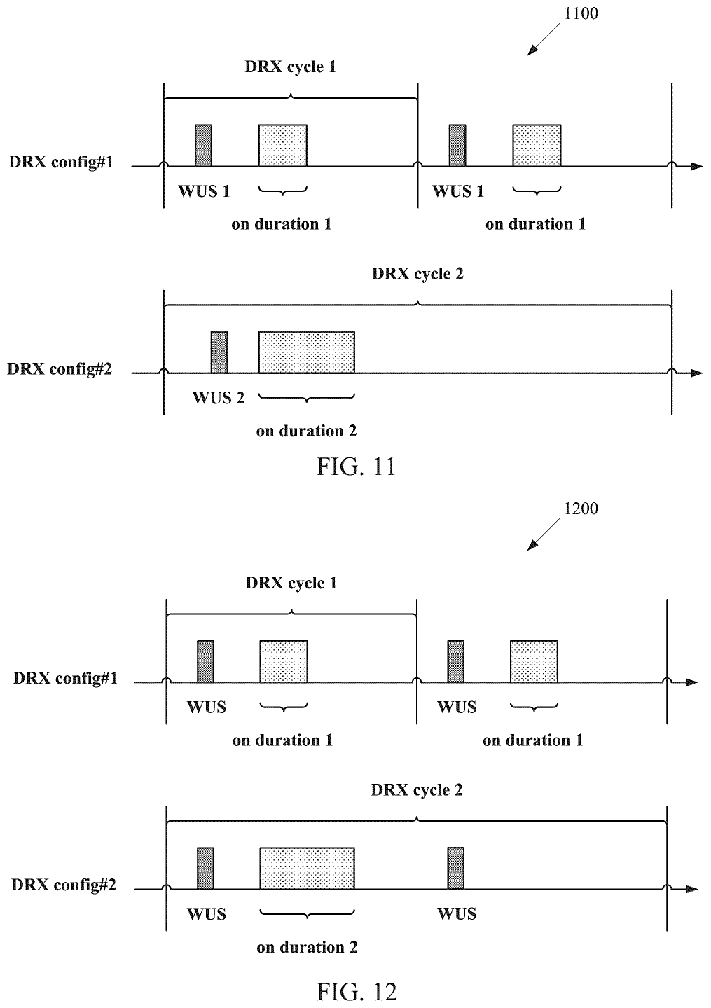

For one embodiment, the occasion(s) for receiving the first SCI format can be determined based on a set of configurations, wherein the occasion(s) can be divided into K groups, and each group corresponds to a SL DRX configuration (e.g., K SL DRX configurations associated with the destination layer-2 ID). An illustration of this embodiment is shown in FIG. 11.

FIG. 11 illustrates an example of a wake-up indication per DRX configuration 1100 according to embodiments of the present disclosure. An embodiment of the wake-up indication per DRX configuration 1100 shown in FIG. 11 is for illustration only.

For one example, one group of occasion(s) for receiving the first SCI format can be determined as a time domain window before the start of the corresponding active time duration (e.g., on duration timer) in the corresponding DRX cycle.

For one instance, the starting location of the time domain window can be determined by a time domain offset with respect to the start of the corresponding active time duration (e.g., on duration timer) in the corresponding DRX cycle, wherein the time domain offset can be provided by a higher layer parameter and/or a pre-configuration.

For another instance, the duration of the time domain window can be provided by a higher layer parameter and/or a pre-configuration.

For yet another instance, the gap between the ending time of the time domain window and the starting time of the corresponding active time duration (e.g., on duration timer) in the corresponding DRX cycle may need to be larger than (or no less than) a threshold. For one instance, the threshold can be provided by a higher layer parameter and/or a pre-configuration. For another instance, the threshold can be subject to a UE capability.

For yet another instance, the time domain windows for different groups can be (pre-)configured separately, such as non-overlapping.

For yet another instance, the time domain windows for different groups can be the same.

For another example, one group of occasion(s) for receiving the first SCI format can be determined as a slot before the start of the corresponding active time duration (e.g., on duration timer) in the corresponding DRX cycle.

For one instance, the slot can be determined by a time domain offset with respect to the start of the corresponding active time duration (e.g., on duration timer) in the corresponding DRX cycle, wherein the time domain offset can be provided by a higher layer parameter and/or a pre-configuration.

For another instance, the gap between the slot and the starting time of the corresponding active time duration (e.g., on duration timer) in the corresponding DRX cycle may need to be larger than (or no less than) a threshold. For one instance, the threshold can be provided by a higher layer parameter and/or a pre-configuration. For another instance, the threshold can be subject to a UE capability.

For yet another instance, the slots for different groups can be (pre-)configured separately, such as non-overlapping.

For yet another instance, the slots for different groups can be the same.

For yet another example, the occasion(s) for receiving the first SCI format can be determined as active time for the SL DRX operation.

For one example, the field for a wake-up indication has 1 bit.

For another example, the field for the wake-up indication has 1 bit if a higher layer parameter is provided (e.g., higher layer parameter indicating whether the wake-up indication for SL DRX is enabled), and 0 bit otherwise.

For yet another example, the first SCI format also includes an indication on the index of the SL DRX configuration or QoS profile.

For one example, the field for a wake-up indication taking a first value (e.g., 1) indicates that the UE may need to wake up and receive the second DCI format during an active time duration in a next DRX cycle after the reception of the wake-up indication, for the corresponding SL DRX configuration or QoS profile; and the field for the wake-up indication taking a second value (e.g., 0) indicates that the UE can skip receiving the second DCI format during an active time duration in a next DRX cycle after the reception of the wake-up indication, for the corresponding SL DRX configuration or QoS profile.

For one example, a transmitter UE can transmit more than one the first SCI format before a DRX active time duration (e.g., on duration timer) in each group of occasion(s).

For one instance, a receiver UE can assume the wake-up indication in the more than one the first SCI format in the same group is the same.

For another instance, in the same group of occasion(s), a receiver UE may assume the wake-up indication in a later time domain occasion overrides the wake-up indication in an earlier time domain occasion within the more than one the first SCI format.

For one example, if a UE does not receive any first SCI format in a group of the occasion(s) for receiving the first SCI format, the UE may wake up and receive the second DCI format during an active time duration in a next DRX cycle, with respect to the corresponding SL DRX configuration or QoS profile.

For one example, when a UE is configured with configurations to receive the first SCI format, the procedure for receiving the first SCI format can be terminated by a first MAC CE. For another example, when a UE is indicated to wake up and receive the second SCI format, the procedure for receiving the second SCI format can be terminated by a second MAC CE.

For one embodiment, the occasion(s) for receiving the first SCI format can be determined based on a set of configurations, wherein the occasion(s) are per SL DRX cycle with respect to the shortest SL DRX cycle among multiple SL DRX cycles that are mapped with multiple QoS profiles (or associated with multiple SL DRX configurations) associated with the destination Layer-2 ID. An illustration of this embodiment is shown in FIG. 12.

FIG. 12 illustrates an example of wake-up indication per DRX cycle configuration 1200 according to embodiments of the present disclosure. An embodiment of the wake-up indication per DRX cycle configuration 1200 shown in FIG. 12 is for illustration only.

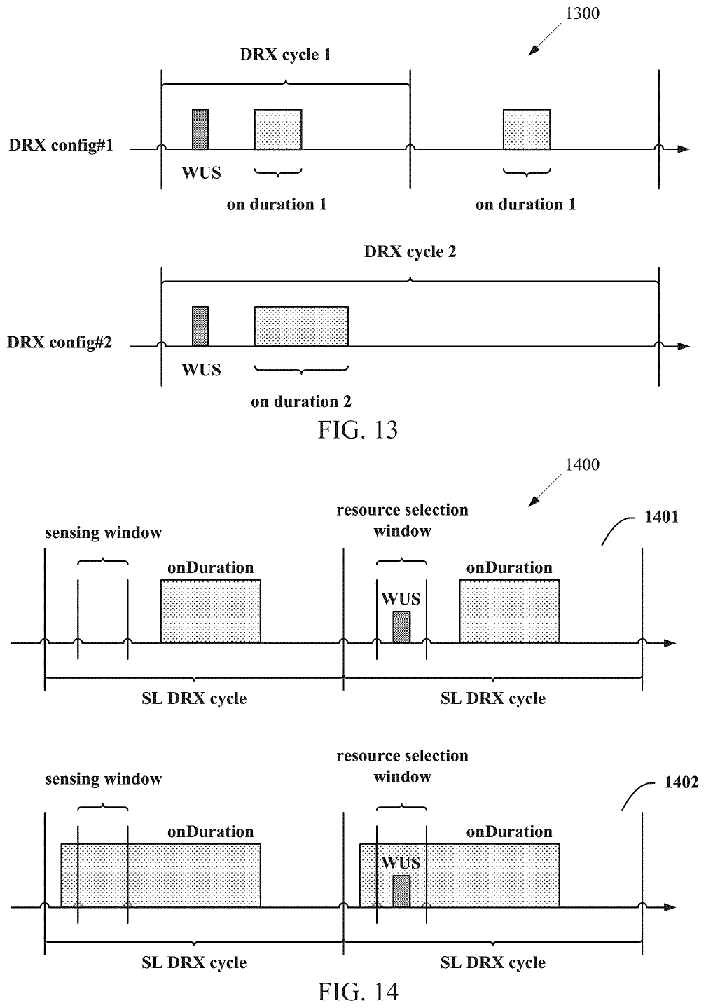

FIG. 13 illustrates an example of common wake-up indication per shortest DRX cycle 1300 according to embodiments of the present disclosure. An embodiment of the common wake-up indication per shortest DRX cycle 1300 shown in FIG. 13 is for illustration only.

For one example, the occasion(s) for receiving the first SCI format can be determined as a time domain window before the start of the active time duration (e.g., on duration timer) in the DRX cycle (e.g., the shortest DRX cycle).

For one instance, the starting location of the time domain window can be determined by a time domain offset with respect to the start of the active time duration (e.g., on duration timer) in the DRX cycle, wherein the time domain offset can be provided by a higher layer parameter and/or a pre-configuration.

For another instance, the duration of the time domain window can be provided by a higher layer parameter and/or a pre-configuration.

For yet another instance, the gap between the ending time of the time domain window and the starting time of the active time duration (e.g., the on duration timer) in the DRX cycle may need to be larger than (or no less than) a threshold. For one instance, the threshold can be provided by a higher layer parameter and/or a pre-configuration. For another instance, the threshold can be subject to a UE capability.

For another example, the occasion(s) for receiving the first SCI format can be determined as a slot before the start of the active time duration (e.g., on duration timer) in the DRX cycle (e.g., the shortest DRX cycle).

For one instance, the slot can be determined by a time domain offset with respect to the start of the active time duration (e.g., on duration timer) in the DRX cycle, wherein the time domain offset can be provided by a higher layer parameter and/or a pre-configuration.

For another instance, the gap between the slot and the starting time of the active time duration (e.g., the on duration timer) in the DRX cycle may need to be larger than (or no less than) a threshold. For one instance, the threshold can be provided by a higher layer parameter and/or a pre-configuration. For another instance, the threshold can be subject to a UE capability.

For yet another example, the occasion(s) for receiving the first SCI format can be determined as active time for the SL DRX operation.

For one example, the field for a wake-up indication has K bit, wherein K is the number of SL DRX configurations (or the number of QoS profiles) associated with the Destination Layer-2 ID.

For another example, the field for the wake-up indication has K bit if a higher layer parameter is provided (e.g., higher layer parameter indicating whether the wake-up indication for SL DRX is enabled), and 0 bit otherwise.

For one example, each bit in the field for a wake-up indication corresponds to a SL DRX configuration or QoS profile, and the bit taking a first value (e.g., 1) indicates that the UE may need to wake up and receive the second DCI format during an active time duration in a next DRX cycle (e.g., the shortest DRX cycle) after the reception of the wake-up indication, for the corresponding SL DRX configuration or QoS profile; and the bit taking a second value (e.g., 0) indicates that the UE can skip receiving the second DCI format during an active time duration in a next DRX cycle (e.g., the shortest DRX cycle) after the reception of the wake-up indication, for the corresponding SL DRX configuration or QoS profile.

For one example, a transmitter UE can transmit more than one the first SCI format before a DRX active time duration (e.g., on duration timer).

For one instance, a receiver UE can assume the wake-up indication in the more than one the first SCI format is the same.

For another instance, a receiver UE may assume the wake-up indication in a later time domain occasion overrides the wake-up indication in an earlier time domain occasion within the more than one the first SCI format.

For one example, if a UE does not receive any first SCI format in the occasion(s) for receiving the first SCI format, the UE may wake up and receive the second DCI format during an active time duration in a next DRX cycle (e.g., the shortest DRX cycle).

For one example, when a UE is configured with configurations to receive the first SCI format, the procedure for receiving the first SCI format can be terminated by a first MAC CE. For another example, when a UE is indicated to wake up and receive the second SCI format, the procedure for receiving the second SCI format can be terminated by a second MAC CE.

For one embodiment, the occasion(s) for receiving the first SCI format can be determined based on a set of configurations, wherein the occasion(s) are per SL DRX cycle with respect to the longest SL DRX cycle among multiple SL DRX cycles that are mapped with multiple QoS profiles (or associated with multiple SL DRX configurations) associated with the destination Layer-2 ID. An illustration of this embodiment is shown in FIG. 13.

For one example, the occasion(s) for receiving the first SCI format can be determined as a time domain window before the start of the active time duration (e.g., on duration timer) in the DRX cycle (e.g., the longest DRX cycle).

For one instance, the starting location of the time domain window can be determined by a time domain offset with respect to the start of the active time duration (e.g., on duration timer) in the DRX cycle, wherein the time domain offset can be provided by a higher layer parameter and/or a pre-configuration.

For another instance, the duration of the time domain window can be provided by a higher layer parameter and/or a pre-configuration.

For yet another instance, the gap between the ending time of the time domain window and the starting time of the active time duration (e.g., on duration timer) in the DRX cycle may need to be larger than (or no less than) a threshold. For one instance, the threshold can be provided by a higher layer parameter and/or a pre-configuration. For another instance, the threshold can be subject to a UE capability.

For another example, the occasion(s) for receiving the first SCI format can be determined as a slot before the start of the active time duration (e.g., on duration timer) in the DRX cycle (e.g., the longest DRX cycle).

For one instance, the slot can be determined by a time domain offset with respect to the start of the active time duration (e.g., on duration timer) in the DRX cycle, wherein the time domain offset can be provided by a higher layer parameter and/or a pre-configuration.

For another instance, the gap between the slot and the starting time of the active time duration (e.g., on duration timer) in the DRX cycle may need to be larger than (or no less than) a threshold. For one instance, the threshold can be provided by a higher layer parameter and/or a pre-configuration. For another instance, the threshold can be subject to a UE capability.

For yet another example, the occasion(s) for receiving the first SCI format can be determined as active time for the SL DRX operation.

For one example, the field for a wake-up indication has X=X_1+X_2+ . . . +X_K bit, wherein X_k=P_max/P_k, 1≤k≤K, K is a number of SL DRX configurations (or the number of QoS profiles) associated with the destination Layer-2 ID, P_k is the DRX cycle for the k-th DRX configuration, and P_max is the longest DRX cycle among the K DRX cycles.

For another example, the field for a wake-up indication has X bit if a higher layer parameter is provided (e.g., higher layer parameter indicating whether the wake-up indication for SL DRX is enabled), and 0 bit otherwise. X=X_1+X_2+ . . . +X_K bit, wherein X_k=P_max/P_k, 1≤k≤K, K is the number of SL DRX configurations (or the number of QoS profiles) associated with the destination Layer-2 ID, P_k is the DRX cycle for the k-th DRX configuration, and P_max is the longest DRX cycle among the K DRX cycles.

For one example, each bit in the field for a wake-up indication corresponds to a SL DRX cycle associated with a SL DRX configuration or QoS profile, and the bit taking a first value (e.g., 1) indicates that the UE may need to wake up and receive the second DCI format during an active time duration in a DRX cycle (e.g., the corresponding DRX cycle within the longest DRX cycle) after the reception of the wake-up indication, for the corresponding SL DRX configuration or QoS profile; and the bit taking a second value (e.g., 0) indicates that the UE can skip receiving the second DCI format during an active time duration in a DRX cycle (e.g., the corresponding DRX cycle within the longest DRX cycle) after the reception of the wake-up indication, for the corresponding SL DRX configuration or QoS profile.

For one example, a transmitter UE can transmit more than one the first SCI format before a DRX active time duration (e.g., on duration timer).

For one instance, a receiver UE can assume the wake-up indication in the more than one the first SCI format is the same.

For another instance, a receiver UE may assume the wake-up indication in a later time domain occasion overrides the wake-up indication in an earlier time domain occasion within the more than one the first SCI format.

For one example, if a UE does not receive any first SCI format in the occasion(s) for receiving the first SCI format, the UE may wake up and receive the second DCI format during an active time duration in a next DRX cycle (e.g., the longest DRX cycle).

For one example, when a UE is configured with configurations to receive the first SCI format, the procedure for receiving the first SCI format can be terminated by a first MAC CE. For another example, when a UE is indicated to wake up and receive the second SCI format, the procedure for receiving the second SCI format can be terminated by a second MAC CE.

In one embodiment, in resource allocation mode 1, resource allocation for a sidelink WUS can be indicated by the gNB.

For example, the resource allocation for the SL WUS can include at least one of a time domain, a frequency domain, and a power domain information on the resource for the SL WUS.

For one instance, the time domain information includes a periodicity for the resource for the SL WUS. For one instance, the periodicity can be (pre-)configured. For another instance, the periodicity can be same as the periodicity for a SL DRX cycle. For yet another instance, the periodicity can be an integer number of the periodicity for a SL DRX cycle (e.g., the integer number can be either fixed or provided by a (pre-)configuration).

For another instance, the time domain information includes an offset for the resource for the SL WUS. For one instance, the offset can be determined comparing to the start of the SL DRX cycle. For another instance, the offset can be (pre-)configured.

For yet another instance, the time domain information includes a number of occasions for the resource for the SL WUS that are associated with one SL DRX cycle. For one instance, the number of occasions can be (pre-)configured. For another instance, the number of occasions can be fixed as 1.

For yet another instance, the time domain information includes an interval between consecutive occasions for the resource for the SL WUS. For one instance, the interval of occasions can be (pre-)configured. For another instance, the set of occasions can be determined as S+(k−1)*I, wherein S is the starting occasion, I is the interval, and k is the index of the occasion within the set of occasions.

For yet another instance, the frequency domain information includes a number of sub-channels. For one instance, the number of sub-channels can be fixed. For another instance, the number of sub-channels can be (pre-)configured. For yet another instance, the number of sub-channels can be indicated in a DCI format.

For yet another instance, the frequency domain information includes information on a starting sub-channel (e.g., an index). For one instance, the starting sub-channel can be fixed. For another instance, the starting sub-channel can be (pre-)configured. For yet another instance, the starting sub-channel can be indicated in a DCI format.

For yet another instance, the power domain information includes a power offset for the SL-WUS. For one instance, the power offset can be (pre-)configured. For another instance, the power offset can be indicated in a DCI format.

For one example, the indication or part of the indication can be included in a DCI format, e.g., the DCI format scheduling sidelink transmission(s).

For one instance, the DCI format can be the DCI format 3_0.

For another instance, the DCI format can be the DCI format 3_1.

For another example, the indication or part of the indication can be provided by a (pre-)configuration.

In one embodiment, in resource allocation mode 2, a UE can determine a subset of resources for SL WUS transmission (e.g., denoting the subset as S_WUS).

For one example, the higher layer can request the UE to determine the subset of resources from which the higher layer can select resources for SL WUS transmission.

For another example, the UE determines the subset of resources and then selects one for SL WUS transmission without reporting to the higher layer.

For one example, the UE determines the subset of resources for SL WUS transmission from a time duration, e.g., a resource selection window given by [T_1, T_2].

For one example, the subset of resources can be determined from slots in the corresponding resource pool (e.g., for PSSCH/PSCCH/PSFCH transmissions) and within the time duration. For one further consideration, the slots in the time duration are not used for resource allocation for PSSCH transmission (e.g., resources in the slots in the time duration are excluded from the set S_A for reporting to the higher layer for resource selection for PSSCH transmission).

For another example, the slots in the time duration can formulate a dedicated resource pool for SL WUS transmission. For one instance, the slots in the time duration are excluded from the resource pool for PSSCH/PSCCH/PSFCH transmissions. For another instance, the slots in the time duration excluding the slots including S-SSB occasions are determined as the slots associated with the dedicated resource pool for SL WUS transmission.

For yet another example, the time duration can be determined per SL DRX cycle. For one instance, the time duration can occur before the start of an active time duration (e.g., ON duration timer) of a SL DRX cycle (e.g., T_2≤T, wherein T is the starting time instance of the active time duration (e.g., ON duration timer) of the SL DRX cycle). For one further consideration, T_2+T_{2, proc}≤T, wherein T_{2, proc} is the processing time for receiving the SL WUS and/or preparation for receiving SCI in the active time duration (e.g., ON duration timer). For another instance, the time duration can occur after the start of an active time duration (e.g., ON duration timer) of a SL DRX cycle and within the active time duration (e.g., ON duration timer) of the SL DRX cycle (e.g., T_1≥T, wherein T is the starting time instance of the active time duration (e.g., ON duration timer) of the SL DRX cycle). For one further consideration, the start time of the time duration can be aligned with the start of the active time duration (e.g., ON duration timer), e.g., T_1=T.

For yet another example, T_1 can be (pre-)configured or determined based on a (pre-)configuration. For one instance, there can be a minimum value requirement on the T_1, e.g., T_1≥T_{1, min}. For another instance, there can be a maximum value requirement on the T_1, e.g., T_1≤T_{1, max}.

For yet another example, T_2 can be (pre-)configured or determined based on a (pre-)configuration. For one instance, there can be a minimum value requirement on the T_2, e.g., T_2≥T_{2, min}. For another instance, there can be a maximum value requirement on the T_2, e.g., T_2≤T_{2, max}.

For one example, a candidate resource for transmission R_{x, y} is determined as a set of contiguous sub-channels with starting sub-channel index x within slot t′_y, where t′_y is from the set of slots in the resource pool and in the resource selection window.

For one example, the candidate resource(s) in the resource selection window can be excluded from the subset of resources for SL WUS transmission (S_WUS), according to sensing result from resources in at least one sensing window.

For one example, the at least one sensing window can include one sensing window defined by [T_A, T_B]. For one instance, T_A can be (pre-)configured or determined based on a (pre-)configuration. For another instance, T_B can be (pre-)configured or determined based on a (pre-)configuration.

For another example, the at least one sensing window can include K resource selection windows prior to the current selection window. For one instance, K can be fixed, e.g., K=1. For another instance, K can be (pre-)configured. For yet another instance, K can be selected between 1 and maximum value, wherein the maximum value can be either fixed or (pre-)configured.

For one example, a candidate resource R_{x, y} in the resource selection window can be excluded from S_WUS, if the UE did not perform sensing in slot t_y−k*P in the at least one sensing window.

For one example, t_y is the physical slot corresponding to slot t′_y in the resource pool.

For another example, k is the index of the at least one sensing window, e.g., corresponding to the k-th resource selection window prior to the current resource selection window.

For yet another example, P is the interval between the resource selection window and the at least one sensing window, e.g., P is same as the DL DRX cycle.

For yet another example, sensing includes a SCI decoding and/or a reference signal received power (RSRP) measurement in the slot.

For another example, a candidate resource R_{x, y} in the resource selection window can be excluded from S_WUS, if the UE performed sensing in slot t_y−k*P in the at least one sensing window, and at least one of the following examples applies.

For one example, t_y is the physical slot corresponding to slot t′_y in the resource pool.

For another example, k is the index of the at least one sensing window, e.g., corresponding to the k-th resource selection window prior to the current resource selection window.

For yet another example, P is the interval between the resource selection window and the at least one sensing window, e.g., P is same as the DL DRX cycle.

For yet another example, sensing includes a SCI decoding and/or a RSRP measurement in the slot.

For yet another example, the UE receives a SCI format in slot t_y−k*P. For one instance, the SCI format includes a wake-up indication indicating the UE either needs to monitor SCI in the next SL DRX cycle or not. For another instance, the SCI format includes an indication on the number of reserved resource for the SL WUS transmission, and the UE can determine R_{x, y} is reserved by the SCI format.

For yet another example, the UE performs RSRP measurement for the received SCI format and determines the RSRP is higher than a threshold.

FIG. 14 illustrates an example of sensing windows and resource selection window for SL WUS 1400 according to embodiments of the present disclosure. An embodiment of the sensing windows and resource selection window for SL WUS 1400 shown in FIG. 14 is for illustration only.

For one example, an illustration of the embodiment is shown in FIG. 14. Resource selection window and/or sensing window(s) located before the associated active time duration (e.g., ON duration timer) of the SL DRX cycle is shown in 1401 as illustrated in FIG. 14, and resource selection window and/or sensing window(s) located within the associated active time duration (e.g., ON duration timer) of the SL DRX cycle is shown in 1402 as illustrated in FIG. 14. In this figure, the at least one sensing window include one sensing window for illustration purpose, and it can be generalized to more than one sensing window according to same relative location between the sensing window and the associated active time duration (e.g., ON duration timer).

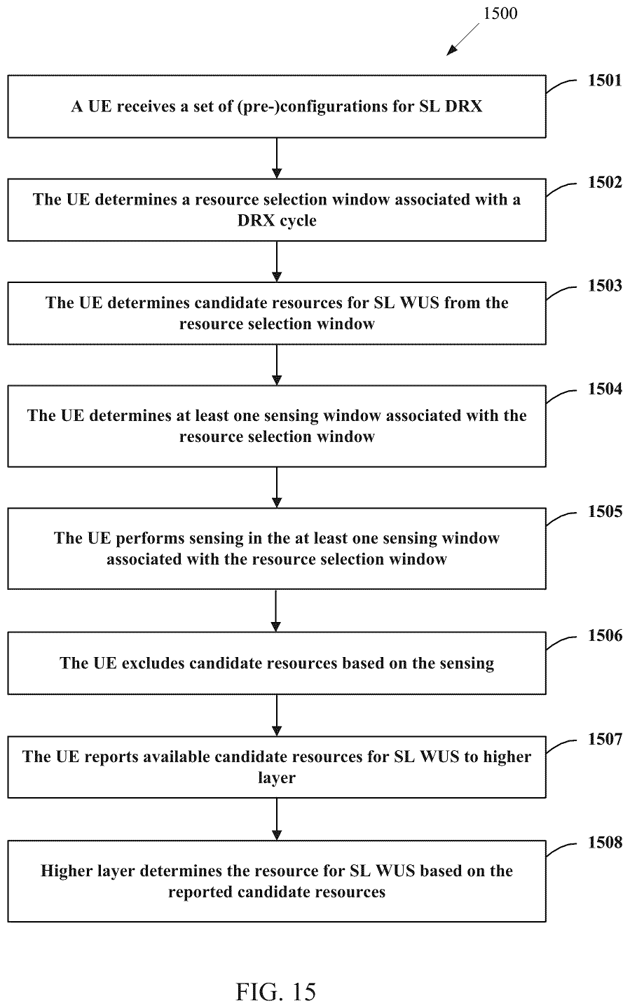

FIG. 15 illustrates a flowchart of UE method 1500 for resource allocation of SL WUS in mode 2 according to embodiments of the present disclosure. The UE method 1500 as may be performed by a UE (e.g., 111-116 as illustrated in FIG. 1). An embodiment of the UE method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

For one example, an example UE procedure for resource allocation of SL WUS in mode 2 is shown in FIG. 15.

As illustrated in FIG. 15, in step 1501, a UE receives a set of configurations (e.g., pre-configuration) for SL DRX. In step 1502, the UE determines a resource selection windows associated with the DRX cycle. In step 1504, the UE determines candidate resources for SL WUS. In step 1504, the UE determines at least one sensing window associated with the resource selection window. In step 1505, the UE performs sensing that at least one sensing window associated with the resource selection window. In step 1506, the UE excludes candidate resources based on the sensing. In step 1507, the UE reports available candidate resources for SL WUS to higher layer. In step 1508, the higher layer determines the resources for SL WUS based on the reported candidate resources.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of configurations or pre-configurations; and
a processor operably coupled to the transceiver, the processor configured to:
determine, based on the set of configurations or pre-configurations, at least one sidelink (SL) discontinuous reception (DRX) configuration;
determine a DRX cycle based on the at least one SL DRX configuration;
determine an active time duration in the DRX cycle;
determine reception occasions of a first sidelink control information (SCI) format that are before a start of the active time duration;
determine whether the first SCI format is received based on the reception occasions; and
when the first SCI format is received in the reception occasions, determine, based on an indication in the first SCI format, whether to receive a second SCI format in the active time duration.

2. The UE of claim 1, wherein, when a resource allocation mode is a first mode, the transceiver is further configured to receive, from a base station (BS), time domain and frequency domain information of the reception occasions.

3. The UE of claim 2, wherein the time domain and frequency domain information is indicated in a downlink control information (DCI) format.

4. The UE of claim 1, wherein, when a resource allocation mode is a second mode, the processor is further configured to determine time domain and frequency domain information of the reception occasions from a resource selection window.

5. The UE of claim 4, wherein slots in the resource selection window are:
from a first SL resource pool for a physical sidelink shared channel (PSSCH), a physical sidelink control channel (PSCCH), or a physical sidelink feedback channel (PSFCH); or
from a second SL resource pool for the first SCI format.

6. The UE of claim 4, wherein:
the time domain and frequency domain information of the reception occasions is determined based on a sensing result from a resource sensing window, and the resource sensing window is before the resource selection window.

7. The UE of claim 1, wherein, when the first SCI format is associated with a unicast transmission, the DRX cycle is associated with a pair of a layer 2 (L2) destination identity (ID) and a L2 source ID.

8. The UE of claim 1, wherein, when the first SCI format is associated with a groupcast transmission or a broadcast transmission, the DRX cycle is associated with a layer 2 (L2) destination identity (ID), and applicable for all quality of service (QoS) profiles.

9. The UE of claim 1, wherein the transceiver is further configured to receive the second SCI format during the active time duration of the DRX cycle when the first SCI format is not received based on the reception occasions.

10. The UE of claim 1, wherein:
the transceiver is further configured to receive a third SCI format based on the reception occasions, and
an indication in the third SCI format on whether to receive the second SCI format during the active time duration in the DRX cycle is same as the indication in the first SCI format.

11. A method of a user equipment (UE) in a wireless communication system, the method comprising:
receiving a set of configurations or pre-configurations;
determining, based on the set of configurations or pre-configurations, at least one sidelink (SL) discontinuous reception (DRX) configuration;
determining a DRX cycle based on the at least one SL DRX configuration;
determining an active time duration in the DRX cycle;
determining reception occasions of a first sidelink control information (SCI) format that are before a start of the active time duration;
determining whether the first SCI format is received based on the reception occasions; and
when the first SCI format is received in the reception occasions, determining, based on an indication in the first SCI format, whether to receive a second SCI format in the active time duration.

12. The method of claim 11, further comprising:
receiving, from a base station (BS), time domain and frequency domain information of the reception occasions when a resource allocation mode is a first mode.

13. The method of claim 12, wherein the time domain and frequency domain information is indicated in a downlink control information (DCI) format.

14. The method of claim 11, further comprising:
determining time domain and frequency domain information of the reception occasions from a resource selection window when a resource allocation mode is a second mode.

15. The method of claim 14, wherein slots in the resource selection window are:
from a first SL resource pool for a physical sidelink shared channel (PSSCH), a physical sidelink control channel (PSCCH), or a physical sidelink feedback channel (PSFCH); or
from a second SL resource pool for the first SCI format.

16. The method of claim 14, wherein:
the time domain and frequency domain information of the reception occasions is determined based on a sensing result from a resource sensing window, and the resource sensing window is before the resource selection window.

17. The method of claim 11, wherein when the first SCI format is associated with a unicast transmission, the DRX cycle is associated with a pair of a layer 2 (L2) destination identity (ID) and a L2 source ID.

18. The method of claim 11, wherein, when the first SCI format is associated with a groupcast transmission or a broadcast transmission, the DRX cycle is associated with a layer 2 (L2) destination identity (ID), and applicable for all quality of service (QoS) profiles.

19. The method of claim 11, further comprising:
receiving the second SCI format during the active time duration of the DRX cycle when the first SCI format is not received in the reception occasions.

20. The method of claim 11, further comprising:
receiving a third SCI format based on the reception occasions,
wherein an indication in the third SCI format on whether to receive the second SCI format during the active time duration in the DRX cycle is same as the indication in the first SCI format.
